(19) United States
(12) Patent Application Publication
(10) Pub. No.: US 2020/0304342 A1
(43) Pub. Date: Sep. 24, 2020

(54) INTELLIGENT MONITORING GATEWAY FOR NUMERICAL CONTROL MACHINE TOOL BASED ON INTERNET OF THINGS

(71) Applicant: DALIAN UNIVERSITY OF TECHNOLOGY, Dalian (CN)

(72) Inventor: Feng QIAN, Dalian (CN)

(21) Appl. No.: 16/894,447

(22) Filed: Jun. 5, 2020

Related U.S. Application Data
(63) Continuation-in-part of application No. PCT/CN2018/074671, filed on Jan. 31, 2018.

(30) Foreign Application Priority Data
Dec. 5, 2017 (CN) 201711267916.3

(51) Int. Cl. H04L 12/66; H04L 29/08; H04L 29/06

(52) U.S. Cl. CPC H04L 12/66; H04L 69/18; H04L 67/2823

(57) ABSTRACT

An intelligent monitoring gateway of a numerical control machine tool based on Internet of Things includes an adaption unit configured to perform unified conversion on uplink data of each numerical control system and upload the converted uplink data to a database storage unit via an ethernet interface, and to convert downlink data issued by an agent unit into a data format matched with each numerical control system and transmit the data format to the corresponding numerical control system. The database storage unit is configured to store the uplink data uploaded by each numerical control system. The agent unit is configured to realize API conversion of the uplink data and the downlink data and is connected to an upper computer by adopting a unified physical interface and a protocol standard. The agent unit includes a real-time agent module, a first protocol agent module and a second protocol agent module.

### TECHNICAL FIELD

The present disclosure relates to an intelligent monitoring gateway for numerical control machine tool based on internet of things, which is used to realize data collection, monitoring and management of numerical control machine tool based on the Internet of Things.

### BACKGROUND

The numerical control machine tool is an automated machine tool with a program control system, which has the advantages of high machining efficiency, high precision and stable quality, is suitable for the highly flexible and automated production field, and is of a basic component of the numerical control production line. However, in actual production, in order to meets the requirements of production process and scheduling of different products, the numerical control machine tools of the production line are provided by different suppliers, resulting in different hardware interface standards, bus standards and numerical control systems throughout the production line, thereby causing the problems such as information closure, low utilization efficiency, difficulty in unified monitoring and management of the production line, high cost and the like, which are not conducive to remould and upgrading of existing production lines and rapid establishment of new production lines.

At the same time, with the continuous improvement and development of the Internet of Things technology and the expansion of the application field, there is provided a new development opportunity for the field of machining control, and provided new ideas and methods for management, monitoring and information integration of numerical control production lines. The concept of Internet of Things (IoT for short) was first proposed by the Massachusetts Institute of Technology. It is an extension and expansion based on Internet to realize the information exchange and communication between any items through technologies such as intellisense, technical identification and pervasive computing. The intelligent manufacturing model characterized by deep integration of information technology and manufacturing technology is the direction of future development of the manufacturing industry.

Therefore, it is important to study gateway devices or systems based on IoT technology to realize data collection, monitoring and management of numerical control machine tools.

### SUMMARY

In view of the defects of the prior art, the present disclosure provides an intelligent monitoring gateway for numerical control machine tool based on the Internet of Things, which can realize interconnection and intercommunication of different types of automated numerical control devices, can be compatible with different hardware interfaces, software protocols and numerical control systems, can provide a multi-standard data reading interface, and has the functions such as real-time data collection, remote on-off control, and numerical control program network management.

The technical solution of the present disclosure is as follows:

An intelligent monitoring gateway for numerical control machine tool based on Internet of Things, which is provided in a communication network composed of an upper computer and a plurality of automated numerical control devices to be monitored, comprises:

an adapter unit connected to numerical control system corresponding to each automated numerical control device to be monitored, which is configured to perform unified conversion on uplink data of each numerical control system and upload the converted data to a database storage unit via an Ethernet interface, and to convert downlink data sent by an agent unit into a data format matching each numerical control system and transmit the data format to the corresponding numerical control system;

the database storage unit connected to the adaption unit and the agent unit respectively, which is configured to store the uplink data uploaded by each numerical control system; and

the agent unit connected to the adapter unit and the database storage unit, which is configured to implement API conversion of the uplink data and the downlink data and is connected to the upper computer by adopting a unified physical interface and a unified protocol standard; the agent unit comprises a real-time agent module, a first protocol agent module and a second protocol agent module, wherein the real-time agent module is connected to the adapter unit and can be configured to provide a real-time protocol standard for the gateway and transmit the downlink data sent by the upper computer to the adapter unit; the first protocol agent module can be configured to provide an uplink data transfer channel based on OPCServer protocol interface for the gateway; and the second protocol agent module can be configured to provide an uplink data transfer channel based on MTConnetct protocol interface for the gateway.

In some implementations, the gateway also has a multi-interface protocol device interworking unit, which comprises:

a compatible input interface, at least including RS232 serial port, RS485 serial port, RS422 serial port, TCP/IP network interface, Wifi network interface, Ethernet bus interface, Profibus bus interface, CAN bus interface, and Modbus bus interface; and

an output physical interface, at least including ASCII text output interface, SQL Server data table output interface, Telnet interactive output interface, OPC output interface, and MTconnect output interface. Therefore, the different interface requirements of each automated numerical control device to be monitored are met, so as to realize the interconnection and intercommunication of different types of automated numerical control devices.

In some implementations, the adapter unit comprises a plurality of adapters which are capable of matching various types of numerical control systems, at least including the adapters corresponding to numerical control systems such as Fanuc, GSK CNC, Huazhong CNC, Shenyang Golding Numerical Control, ABB, Mitsubishi, Siemens, Heidenhain, MAG, HAAS and so on.

In some implementations, the real-time agent module can be configured to, when the upper computer sends downlink data, parse a corresponding target address code from the downlink data, then convert the downlink data into a data format matching a data system corresponding to the target address code and transmit the data format through the adapter unit. That is, the process of converting general API interface data into dedicated API interface data can be completed, the dedicated API interface data is data that matching a data system corresponding to the target address code.

In some implementations, the first protocol agent module further has an open logical interface, and is configured to, in the case that an uplink data transfer channel based on the OPC Server protocol interface is provided for the gateway, mark a source address code of the uplink data and upload the uplink data to the upper computer in general data format and hardware interface form; the second protocol agent module further has an open logical interface, and is configured to, in the case that an uplink data transfer channel based on the MTConnect protocol interface is provided for the gateway, mark a source address code of the uplink data and upload the uplink data to the upper computer in general data format and hardware interface form. That is, the process of converting dedicated API interface data into general API interface data into can be completed, the dedicated API interface data is data that matching a data system corresponding to the source address code.

Compared with the prior art, the present disclosure has the following beneficial effects:

a. the intelligent gateway of the present disclosure can realize the interconnection and intercommunication of different types of automated devices through a multi-interface protocol device interworking unit, and can quickly establish Internet of Things for automated devices in a factory;

b. the intelligent gateway of the present disclosure can realize real-time data collection and storage of an operating state of the automated device, in which various information data are involved, such as operating state, operating time, machining data, alarm information, cutter information and program information of numerical control device, which covers most of data of digital manufacturing production line and provides a multi-standard data reading interface; and

c. the intelligent gateway of the present disclosure can realize network management, remote on-off control, and real-time big data management of automated device operating programs. Centralized management of numerical control device machining programs involves uploading, downloading, deletion and reviewing of programs, and the like. Execution, parking and the like of the numerical control devices on the production line can be controlled remotely, the production line management is coordinated according to production scheduling without going to the production line to operate one by one, thereby improving the management efficiency and management flexibility. The intelligent monitoring gateway has real-time big data processing capabilities, such as large-scale data window operations, relational real-time databases, data disaster recovery management, and the like.

### BRIEF DESCRIPTION OF THE DRAWINGS

FIG. 1 is a structural schematic diagram of the present disclosure; and

FIG. 2 is a schematic diagram showing an example corresponding to the gateway of the present disclosure.

### DETAILED DESCRIPTION

To make the objects, technical solutions and advantages of the present disclosure clearer, the technical solution of the present disclosure is described in detail with reference to the drawings. It is apparent that the described embodiments are a part of the embodiments of the present disclosure, rather than all of the embodiments. All other embodiments obtained by those common skilled in the art based on the embodiments in the present disclosure without creative work fall within the protection scope of the present disclosure.

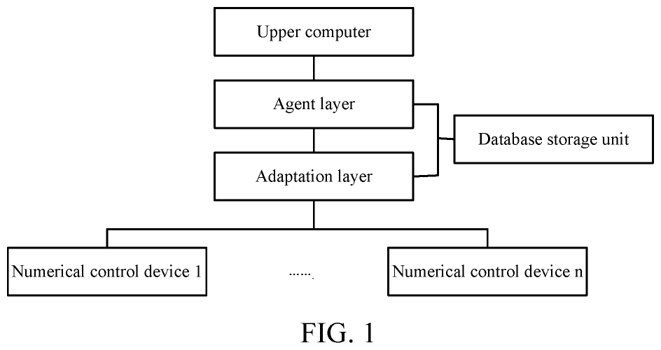

As shown in FIG. 1, the intelligent monitoring gateway for numerical control machine tool based on Internet of Things of the present disclosure is provided in a communication network composed of an upper computer and a plurality of automated numerical control devices to be monitored, comprising:

an adapter unit connected to numerical control system corresponding to each automated numerical control device to be monitored, which is configured to perform unified conversion on uplink data of each numerical control system and upload the converted data to a database storage unit via an ethernet interface, and to convert downlink data sent by an agent unit into a data format matching each numerical control system and transmit the data format to the corresponding numerical control system;

the database storage unit connected to the adapter unit and the agent unit respectively, which is configured to store the uplink data uploaded by each numerical control system; the database storage unit is a memory storing the database, for example a non-volatile memory, a portable memory such as a flash drive or a hard disk; and

the agent unit connected to the adapter unit and the database storage unit, which is configured to realize API conversion of the uplink data and the downlink data, and is connected to the upper computer by adopting a unified physical interface and a unified protocol standard; the agent unit comprises a real-time agent module, a first protocol agent module and a second protocol agent module, wherein the real-time agent module, i.e. a fanuc focas interface, is connected to the adapter unit and can be configured to provide a real-time protocol standard for the gateway and transmit the downlink data sent by the upper computer to the adapter unit; the first protocol agent module can be configured to provide an uplink data transfer channel based on an OPCServer protocol interface for the gateway; the second protocol agent module can be configured to provide an uplink data transfer channel based on MTConnetct protocol interface for the gateway.

In another implementation, the gateway also has a multi-interface protocol device interworking unit, which comprises:

a compatible input interface, at least including RS232 serial port, RS485 serial port, RS422 serial port, TCP/IP network interface and Wifi network interface as physical interface, and Ethernet bus interface, Profibus bus interface, CAN bus interface and Modbus bus interface as field bus interface; and

a output physical interface, at least including ASCII text output interface, SQL Server data table output interface, Telnet interactive output interface, OPC output interface, and MTconnect output interface; and

meanwhile, the gateway further supports networking structures such as star structure, bus structure, and hierarchical structure to meet the different interface requirements of each automated numerical control device to be monitored, thereby realizing the interconnection and intercommunication of different types of automated numerical control devices.

In another implementation, the adapter unit comprises a plurality of adapters matching different types of numerical control systems. The adapters at least include adapters corresponding to numerical control systems, such as Fanuc Numerical Control, GSK Numerical Control series, Huazhong Numerical Control series, Shenyang Golding Numerical Control series, ABB series, Mitsubishi Numerical Control series, Siemens Numerical Control series, Heidenhain series, MAG series, and HAAS Numerical Control series. Each of the above adapters performs unified API conversion on the uplink data uploaded by a device layer formed by respective numerical control systems (that is, completes the conversion of designated API with general API of the numerical control system), and then transmits the converted uplink data to the database storage unit through a unified Ethernet interface form; and meanwhile, performs API conversion on downlink data of the agent unit, and transmits the converted downlink data to the corresponding numerical control system through hardware and bus interface that are compatible with each numerical control system, thereby completing the unified process of implementing hardware interface standards in adapter layer formed by the adapter unit.

In another implementation, the database storage unit adopts SQL92 standard-based database that is capable of storing uplink data (such as state information, machining information and the like of machine tool) uploaded by each of the numerical control systems in real time.

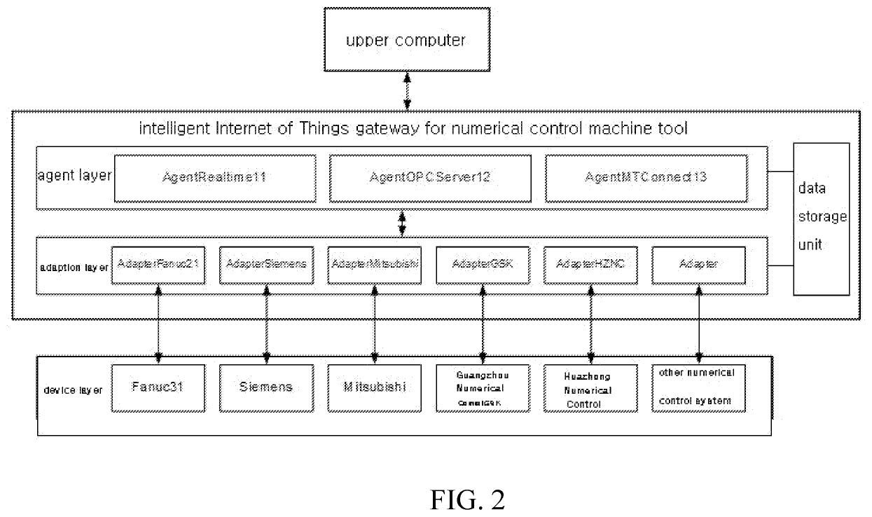

In another implementation, as shown in FIG. 2, the agent unit is mainly configured to provide a unified physical interface and protocol standard for the uplink data and downlink data of the upper computer, for example, providing OPCServer protocol-based interface and MTConnect protocol-based interface, so that the agent unit has good openness, programmable, and compatible with various systems. In detailed, the real-time agent module uses real-time protocol and directly connect to the adapter unit, and can be configured to, when the upper computer sends the downlink data, parse a corresponding target address code from the downlink data, then convert the downlink data into a data format matching a data system corresponding to the target address code, and transmit the data format through the adapter unit, i.e. completing the process of converting the general API interface data into dedicated API interface data matching a data system corresponding to the target address code.

The first protocol agent module (OPC Server protocol agent module for example) further has an open logical interface, and is configured to, in the case that an uplink data transfer channel based on the OPCServer protocol interface is provided for the gateway, mark a source address code of the uplink data and upload the uplink data to the upper computer in general data format and hardware interface form; the second protocol agent module (MTConnect protocol agent module for example) further has an open logical interface, and is configured to, in the case that an uplink data transfer channel based on the MTConnect protocol interface is provided for the gateway, mark a source address code of the uplink data and upload the uplink data to the upper computer in general data format and hardware interface form. That is, the process of converting dedicated API interface data into general API interface data can be completed, and the dedicated API interface data is data matching a data system corresponding to the source address code. The agent unit is configured to provide a unified physical interface and protocol standard for the gateway, for example, ASCII text, SQL Server data table and Telnet protocol are edited and defined by the real-time agent module, and OPC and MTconnect international standard interfaces are provided for the gateway through the first protocol agent module and the second protocol agent module, so as to realize the unified connection between the upper computer and different numerical control systems. The gateway supports star structure, bus structure, hierarchical structure and the like. Further, based on this multi numerical control system integrated gateway, the following functions are provided for the upper computer by compiling corresponding adapter programs and integrating related function plug-ins for each numerical control system: machine tool state data monitoring (operating state, operating time, cutting time, rotation speed of each shaft, feed rate, power load, coordinate information, cutter information, program information, number of workpieces, etc.); abnormal alarm shutdown processing; numerical control program management (program uploading, program downloading, program list, program deletion, remote execution, remote machine halt, execution state, etc.); and real-time big data management (multi-scale data window, relational real-time database, data disaster recovery management, etc.).

The real-time monitoring management function can realize: real-time data collection, remote on-off control, and network-based programming of numerical control programs. The real-time monitoring management function includes: machine tool state data monitoring (operating state, operating time, cutting time, rotation speed of each shaft, feed rate, power load, coordinate information, cutter information, program information, number of workpieces, etc.); abnormal alarm shutdown processing; network-based management of numerical control program (program uploading, program downloading, program list, program deletion, remote execution, remote machine halt, execution state, etc).

From the above, the gateway provided by the present disclosure is capable of realizing the interconnection and intercommunication of automated devices in different types, is compatible with different hardware interfaces, software protocols and numerical control systems, and provides a multi-standard data reading interface; the gateway has the functions of real-time data collection, remote on-off control, numerical control program network-based management and the like; the gateway can realize rapid establishment of the Internet of Things for automated devices in factory, and can thus be widely used in the field of intelligent manufacturing.

The present disclosure is not limited to the embodiments, and the protection scope of the present invention is not limited thereto. Any equivalent replacement or changes made by those skilled in the art according to the technical solution and the inventive concept thereof within the technical scope of the present disclosure are intended to be included within the protection scope of the present disclosure.

1. An intelligent monitoring gateway for numerical control machine tool based on Internet of Things, which is provided in a communication network composed of an upper computer and a plurality of automated numerical control devices to be monitored, comprising:
an adapter unit connected to numerical control system corresponding to each automated numerical control device to be monitored, which is configured to perform unified conversion on uplink data of each numerical control system and upload the converted data to a database storage unit via an Ethernet interface, and to convert downlink data sent by an agent unit into a data format matching each numerical control system and transmit the data format to the corresponding numerical control system;
the database storage unit connected to the adapter unit and the agent unit respectively, which is configured to store the uplink data uploaded by each numerical control system; and
the agent unit connected to the adapter unit and database storage unit, which is configured to implement API conversion of the uplink data and downlink data, and is connected to the upper computer by adopting a unified physical interface and a unified protocol standard; the agent unit comprises a real-time agent module, a first protocol agent module and a second protocol agent module, wherein the real-time agent module is connected to the adapter unit and can be configured to provide a real-time protocol standard for the gateway and transmit the downlink data sent by the upper computer to the adapter unit; the first protocol agent module can be configured to provide an uplink data transfer channel based on OPCServer protocol interface for the gateway; and the second protocol agent module can be configured to provide an uplink data transfer channel based on MTConnetct protocol interface for the gateway.

2. The intelligent monitoring gateway for numerical control machine tool based on Internet of Things according to claim 1, wherein
the gateway has a multi-interface protocol device interworking unit, comprises:
a compatible input interface at least including RS232 serial port, RS485 serial port, RS422 serial port, TCP/IP network interface, Wifi network interface, Ethernet bus interface, Profibus bus interface, CAN bus interface, and Modbus bus interface; and
an output physical interface at least including ASCII text output interface, SQL Server data table output interface, Telnet interactive output interface, OPC output interface, and MTconnect output interface.

3. The intelligent monitoring gateway for numerical control machine tool based on Internet of Things according to claim 1, wherein
the real-time agent module can be configured to, when the upper computer sends the downlink data, parse a corresponding target address code from the downlink data, then convert the downlink data into a data format matching a data system corresponding to the target address code and transmit the data format through the adapter unit.

4. The intelligent monitoring gateway for numerical control machine tool based on Internet of Things according to claim 1, wherein the first protocol agent module has an open logical interface, and is configured to, in the case that an uplink data transfer channel based on the OPC Server protocol interface is provided for the gateway, mark a source address code of the uplink data and upload the uplink data to the upper computer in general data format and hardware interface form; the second protocol agent module has an open logical interface, and is configured to, in the case that an uplink data transfer channel based on the MTConnect protocol interface is provided for the gateway, mark a source address code of the uplink data and upload the uplink data to the upper computer in general data format and hardware interface form.
